(19) United States
(12) Patent Application Publication
(10) Pub. No.: US 2005/0264544 A1
(43) Pub. Date: Dec. 1, 2005

(54) Display device and driving method thereof

(76) Inventor: Kuo-Han Hsu, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/855,147

(22) Filed: May 27, 2004

(51) Int. Cl. G09G 3/36

(52) U.S. Cl. 345/204

(57) ABSTRACT

A driving method for a display device. The display device includes an over drive (OD) system, a timing controller, an interface, a memory and a display panel. In the method, first image data is received from a host system. The first image data is then converted into an overdriven image data according to a relational table, and stored the overdriven image data in the memory as compensation image data. Next, the display panel is driven according to the overdriven image data. Then, subsequent image data from the host system is received, and it is determined whether the subsequent image data has been interrupted during transmission. Next, the display panel is driven according to the compensation image data stored in the memory if the subsequent image data has been interrupted during transmission.

### BACKGROUND OF THE INVENTION

1. Field of the Invention

The present invention relates to a display device, and more particularly, to a display device capable of preventing flicker caused by interrupted image transmission.

2. Description of the Related Art

Typically, LCDs comprise a control circuit to drive a display panel according to image data received from a host system. However, flicker can occur on the display panel when image data transmission is interrupted.

### SUMMARY OF THE INVENTION

It is therefore an object of the present invention to provide a display device capable of preventing flicker caused by interrupted image transmission.

According to the above mentioned object, the present invention provides a method for driving a display device. The display device comprises at least an overdrive (OD) system, a timing controller, an interface, a memory and a display panel. In the method, first image data from a host system is received by the overdrive system through the interface. The image data is then converted into overdriven image data according to a relational table, and stored in memory as compensation image data. Next, the display panel is driven according to the overdriven image data. A subsequent image data from the host system is received, and it is determined whether the subsequent image data has been interrupted during transmission. If so, the display panel is driven according to the stored compensation image data.

According to the above mentioned object, the present invention also provides a control circuit for driving a display device. In the control circuit, an overdrive system receives first image data transmitted from a host system, converts the first image data into overdriven image data according to a relational table, outputs the overdriven image data for storage in memory as compensation image data. A timing controller coupled to the overdrive system drives the display element according to the overdriven image data. The overdrive system outputs the compensation image data to the timing controller for driving the display element when subsequent image data is interrupted during transmission, thereby preventing flickers.

### BRIEF DESCRIPTION OF THE DRAWINGS

The present invention can be more fully understood by the subsequent detailed description and examples with reference made to the accompanying drawings, wherein:

FIG. 1 is a schematic diagram of the display device according to the present invention;

FIG. 2 is another schematic diagram of the display device according to the present invention; and

FIG. 3 is a flowchart of the driving method according to the present invention.

### DETAILED DESCRIPTION OF THE INVENTION

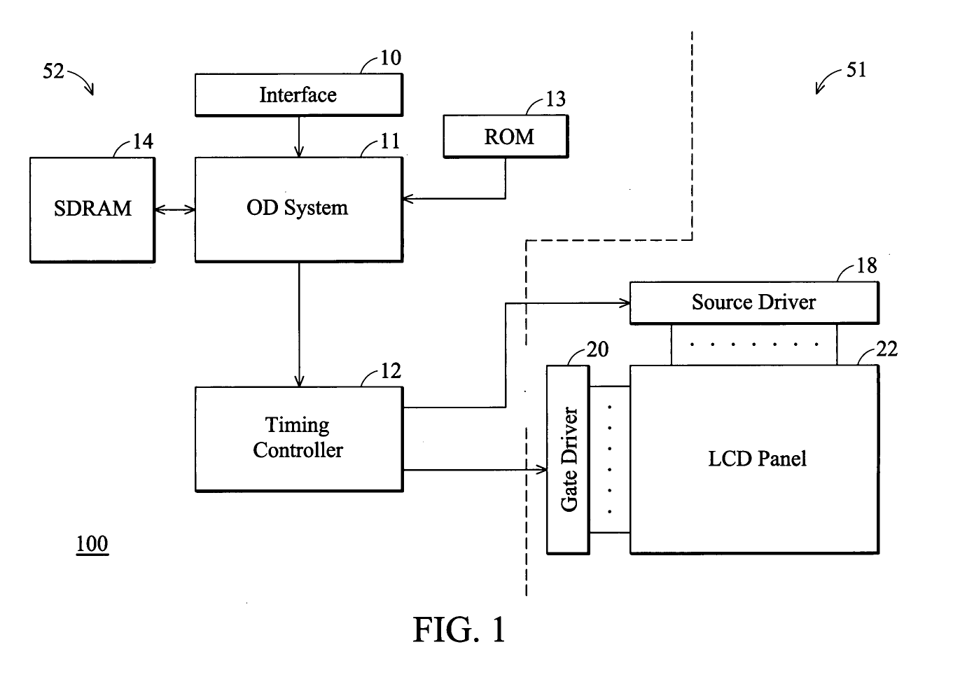

FIG. 1 is a schematic diagram of a display device according to the present invention. As shown in FIG. 1, the display device 100 comprises a control circuit 51 and a display element 52. The control circuit 52 receives data and control signals from a host system to drive the display element 51. For example, the display element 51 can be a LCD display element, comprising a source driver 18, a gate driver 20 and a LCD display panel 22. The LCD panel 22 comprises a plurality of pixels arranged in matrix (not shown), each pixel comprising a corresponding thin film transistor (TFT), a plurality of data lines connected to the switching device providing pixel data thereto and a plurality of scanning lines for applying control signals to control the thin film transistors. The source driver 18 is coupled to the data lines and comprises a plurality of driver ICs (not shown) to provide pixel data to the data lines. The gate driver 20 is coupled to the scanning line and comprises a plurality of driver ICs (not shown) to provide an on/off control of gate terminals of thin film transistors on the LCD panel 22, one by one line, in response to control signals input from the timing controller 12.

The control circuit 52 comprises an interface 10, an overdrive system 11, a timing controller 12, a nonvolatile memory 13 and a memory 14.

In the control circuit 51, the interface 10 receives image data (e.g., RGBdata) and control signals (e.g., an input clock, a horizontal synchronizing signal, a vertical synchronizing signal and a data enable signal) from a host system (not shown) and applies them to the overdrive system 11. For example, a low voltage differential signal (LVDS) interface and a transistor transistor logic (TTL), or others, have been mainly used for data and control signal transmission to display devices. All of such interfaces are integrated into a single chip along with the overdrive system 11, the timing controller 12 and the memory 14. For example, the memory 14 can be a synchronous dynamic random access memory (SDARM), and the nonvolatile memory 13 can be a read only memory (ROM) or a flash memory storing a relational table of image data and corresponding overdrove data thereof.

In the present invention, the overdrive system 11 receives first image data and control signals transmitted from a host system by the interface 10. The overdrive system 11 then converts the first image data into overdriven image data according to the relational table stored in the nonvolatile memory 13, outputs the overdriven image data and control signals to the timing controller 12 and stores the overdriven image data into the memory 14 as compensation image data. The timing controller 12 is coupled to the overdrive system, the source driver 18 and the gate driver 20. The timing controller 12 drives the display element 51 according to the overdriven image data and control signals output from the overdrive system 11. In the embodiment, the overdrive system 11 detects whether subsequent image data from the host system has been interrupted during transmission. The overdrive system 11 outputs the compensation image data stored in the memory 14 to the timing controller 12 for driving the display element 51 if the subsequent image data has been interrupted during transmission.

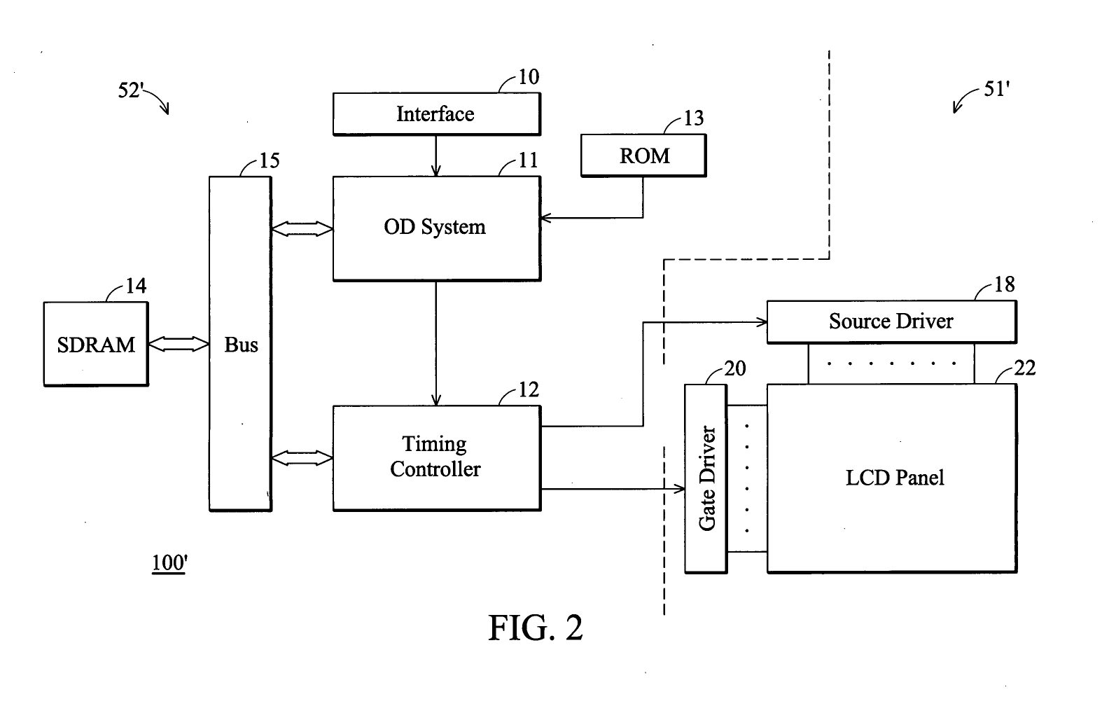

FIG. 2 is another schematic diagram of the display device according to a second embodiment of the present invention. As shown in FIG. 2, in the display device 100′, the bus 15 is coupled to the memory 14, the overdrive system 11 and the timing controller 12. In this embodiment, the overdrive system 11 enables the timing controller 12 to drive the display element 51 via bus 15 according to the compensation image data stored in the memory 14 when the subsequent image data is interrupted during transmission. Thus, the display device 100′ can prevent flicker caused by interrupted image transmission.

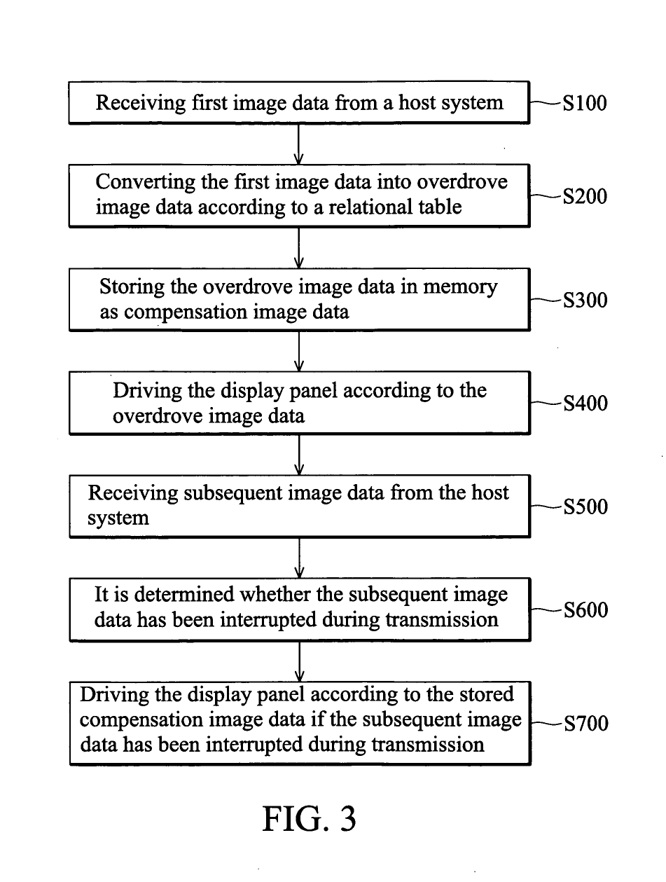

The present invention also provides a method for driving a display device. FIG. 3 is a flowchart of the driving method according to the present invention.

In step S100, first image data and control signals from a host system are received by the overdrive system 11 through the interface 10. In step S200, the overdrive system 11 then converts the first image data into overdriven image data according to a relational table stored in the nonvolatile memory 13. Next, in step s400, the overdrive system 11 outputs the overdriven image data and the control signals to the timing controller 12 and stores the overdriven image data in the memory 14 as compensation image data. Instep s500, the timing controller 12 drives the display panel 22 by the source driver 18 and the gate driver 20 according to the overdriven image data and control signals from the overdrive system 11.

In step s600, the overdrive system 11 then receives subsequent image data and control signals from the host system through the interface 10 and detects whether the subsequent image data has been interrupted during transmission. In step s700, if the second image data is complete, the overdrive system 11 converts the subsequent image data into a second overdriven image data, outputs the control signals and the second overdriven image data to the timing controller 12 and stores the second overdriven image data in the memory 14 to update the compensation image data. The overdrive system 11 then drives the display panel 22 by the source driver 18 and gate driver 20 according to the second overdriven image data and control signal from the overdrive system 11. If the second image data is detected as having been interrupted during transmission, the overdrive system 11 drives the display panel 22 by the data drive 18 and gate drive 20 according to the compensation image data previously stored in the memory 14 (in step s400) and corresponding control signals.

The driving method of the present invention thus drives LCD display device without flicker caused by interrupted image transmission.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for driving a display device comprising an overdrive (OD) system, a timing controller, an interface, a memory and a display panel, the method comprising:
receiving first image data from a host system;
converting the first image data into overdriven image data according to a relational table;
storing the overdriven image data in the memory as compensation image data;
driving the display panel according to the overdriven image data;
receiving subsequent image data from the host system;
detecting whether the subsequent image data has been interrupted during transmission; and
driving the display panel according to the compensation image data stored in the memory if the subsequent image data has been interrupted during transmission.

2. The method as claimed in claim 1, further comprising outputting the compensation image data stored in the memory to the timing controller if the subsequent image data has been interrupted during transmission.

3. A control circuit for driving a display element, comprising:
a memory;
an overdrive system receiving first image data transmitted from a host system, converting the first image data into overdriven image data according to a relational table, outputting the overdriven image data and storing the overdriven image data into the memory as compensation image data; and
a timing controller coupled to the overdrive system to drive the display element according to the overdriven image data output from the overdrive system; wherein the overdrive system outputs the compensation image data stored in the memory to the timing controller for driving the display element if a subsequent image data has been interrupted during transmission.

4. The control circuit as claimed in claim 3, further comprising a bus coupled to the memory, the overdrive system and the timing controller.

5. The control circuit as claimed in claim 3, wherein the display element is a liquid crystal display element.

6. The control circuit as claimed in claim 5, wherein the display element comprises a source driver, a gate driver and a display panel.

7. The control circuit as claimed in claim 6, wherein the memory is synchronous dynamic random access memory (SDARM).

8. The control circuit as claimed in claim 7, further comprising a nonvolatile memory storing the relational table.

9. The control circuit as claimed in claim 8, wherein the nonvolatile memory is read only memory (ROM).

10. A display device, comprising:
a memory;
a display element;
an overdrive system, coupled to the bus to receive first image data transmitted from a host system, convert the first image data into overdriven image data according to a relational table, output the overdriven image data and store the overdriven image data into the memory as compensation image data; and
a timing controller coupled to the bus and the overdrive system to drive the display element according to the overdriven image data; wherein the overdrive system enables the timing controller to drive the display element according to the compensation image data stored in the memory if subsequent image data has been interrupted during transmission.

11. The display device as claimed in claim 10, further comprising a bus coupled to the memory, the overdrive system and the timing controller.

12. The display device as claimed in claim 11, wherein the display element is a liquid crystal display element.

13. The display device as claimed in claim 12, wherein the display element comprises a source driver, a gate driver and a display panel.

14. The display device as claimed in claim 13, wherein the memory is synchronous dynamic random access memory (SDARM).

15. The display device as claimed in claim 14, further comprising a nonvolatile memory storing the relational table.

16. The display device as claimed in claim 15, wherein the nonvolatile memory is read only memory (ROM).
